(19) United States
(12) Patent Application Publication
(10) Pub. No.: US 2022/0106233 A1
(43) Pub. Date: Apr. 7, 2022

(54) USE OF A COMPOSITION COMPRISING A HIGH LEVEL OF INORGANIC MATERIAL(S) AND A THERMOPLASTIC ELASTOMER IN AN ADDITIVE MANUFACTURING PROCESS

(71) Applicants: UNIVERSITÉ DE BRETAGNE SUD, Lorient (FR); CAPNOVIA, Louargat (FR)

(72) Inventors: Yves GROHENS, Guidel (FR); Yves-Marie CORRE, Lorient (FR); Jacques PELLETER, Morlaix (FR)

(73) Assignees: UNIVERSITÉ DE BRETAGNE SUD, Lorient (FR); CAPNOVIA, Louargat (FR)

(21) Appl. No.: 17/490,301

(22) Filed: Sep. 30, 2021

(30) Foreign Application Priority Data
Oct. 2, 2020 (FR) 2010098

(51) Int. Cl. C04B 35/46; B29C 64/118; B29C 64/209; B28B 1/00; C04B 35/634; B33Y 10/00; B33Y 70/10; B33Y 40/20

(52) U.S. Cl. CPC C04B 35/46; B29C 64/118; B29C 64/209; B28B 1/001; C04B 35/63408; C04B 35/6346; C04B 2235/5436; C04B 35/63432; B33Y 10/00; B33Y 70/10; B33Y 40/20; C04B 2235/3232; C04B 35/63488

(57) ABSTRACT

A melt-deposition additive composition including, based on the total weight of the composition, from 75 to 90.75% by weight of at least one inorganic material, and a polymer phase including: from 9 to 20% by weight of at least one thermoplastic elastomer, from 0.25 to 5% by weight of at least one low density polyethylene, from 0 to 5% by weight of at least one polyethylene glycol having a molar mass of from 5,000 to 20,000 g/mol, and from 0 to 3% by weight of polyethylene terephthalate, preferably glycol, for use in a melt-deposition additive manufacturing process. A method for the preparation of a 3D article using this composition, the article obtained comprising at least 99% by weight of inorganic material(s) with respect to the total weight of the article and uses of this article.

### FIELD

The invention relates to the field of production of three-dimensional objects using an additive manufacturing process by deposition of molten material. More particularly, the present invention relates to the production of three-dimensional objects from a composition comprising a high level of inorganic material(s).

### BACKGROUND

Over the past two decades, 3D printing technology, also known as additive manufacturing, has developed rapidly as an emerging technology for rapid prototyping in fields as diverse as aeronautics, biomedical engineering and science education, especially engineering.

This technology uses several methods including selective laser melting (SLM), selective laser sintering (SLS), electron beam melting (EBM), photo-polymerization (SLA), fused deposition and more specifically fused wire deposition (FFF).

The present invention relates more particularly to melt deposition technology. This method consists of using a thermoplastic material, driving this material through an extruder in which it is melted to a print head allowing the deposition, in successive superimposed layers, of the said molten thermoplastic material. The design of the desired article is carried out by depositing it on a predefined 3-dimensional trajectory and assisted by computer. The layer-by-layer solidification of the deposited material is thus controlled to obtain the 3D article. The article obtained at the end of this stage is generally called a “green body”. Then, after a debinding step and possible intermediate steps defined according to the chosen materials, an article called “brown body” is obtained. Finally, the brown part is subjected to a sintering step leading to the final article.

The present invention relates more particularly to the preparation of a three-dimensional article of inorganic material of the metal, metal alloy or ceramic type.

Methods for preparing articles comprising an inorganic material by additive manufacturing are already known. These processes involve a step of manufacturing a green part obtained from an inorganic material and a binder composition, a debinding step enabling the corresponding brown part to be obtained and a sintering step. Thus, patent application U.S. Pat. No. 5,738,817A describes the manufacture of articles comprising an inorganic material of the metal or ceramic type using a binder selected from thermoplastic binders, thermosetting binders, and binders soluble in water or in organic solvents. Patent application WO2016/012486 uses, as the main binder, a polyoxymethylene which is a polymer with a high degree of crystallinity, in a mixture with a polyolefin and at least one other polymer. These processes do not always lead to satisfactory articles: the articles may be deformed and show surface blisters as well as cracks, delaminations, or lead to green parts that are too brittle to be handled or transported easily.

There is still a need for 3D printing compositions and processes that do not have the drawbacks of the prior art technologies.

### SUMMARY

Surprisingly and advantageously, the inventors of the present invention have shown that the use of a binder comprising at least one thermoplastic elastomeric polymer (TPE) and at least one low-density polyethylene makes it possible to obtain articles that do not have the disadvantages of the prior art. Advantageously, the articles obtained by the additive manufacturing process according to the present invention comprise from 99 to 100 weight of inorganic material(s), the complement to 100% being constituted by traces of residual binders.

The invention thus relates to the use of a composition comprising:
a) from 75 to 90.75% by weight of at least one inorganic material relative to the total weight of the composition, and
b) a polymer phase comprising:
from 9 to 20% by weight of at least one thermoplastic elastomer, based on the total weight of the composition,
from 0.25 to 5% by weight of at least one low-density polyethylene, based on the total weight of the composition,
from 0 to 5% by weight of at least one polyethylene glycol having a molar mass of from 5,000 to 20,000 g/mol, based on the total weight of the composition, from 0 to 3% by weight of polyethylene terephthalate, preferably glycol polyethylene terephthalate, based on the total weight of the composition, in a melt-deposition additive manufacturing process.

It also concerns a method of manufacturing an article by 3D printing, comprising the following steps in this order:
i) place a composition used according to the invention in the feed zone of a printer for additive manufacturing by melt deposition,
ii) drive said composition to the print head of the printer composed of a heating body and a printing nozzle where said composition is brought to a temperature Tc comprised between the melting temperature of the composition and said melting temperature of the composition+20° C.,
iii) extrude the molten composition through the nozzle of the printing head to form a three-dimensional green part by deposition of successive layers,
iv) remove at least part of the polymeric part of the green part by heating to form a three-dimensional brown part,
v) sinter the brown part to form an article comprising at least 99% by weight of inorganic material(s) with respect to the total weight of the article.

The invention also relates to an article obtained from the composition used according to the invention or obtained according to the process according to the invention comprising at least 99% by weight of inorganic material(s) with respect to the total weight of the article, as well as to the use of the article according to the invention in aeronautics, in particular in the internal part of engines and in the exhaust part of engines; in jewellery; in devices such as filtering devices, reactors, microreactors, catalysts, and for the local recharging of wear parts.

Other features, properties and advantages of the invention will be clear from the following description, which is indicative and not limiting.

### DETAILED DESCRIPTION

The invention also relates to the embodiments described below. A person skilled in the art will understand that each of the features of the following embodiments may be combined independently with the above features without constituting an intermediate generalisation.

The composition used in the additive manufacturing process according to the present invention may be in the form of pellets or a filament. When the additive manufacturing process is carried out using a composition in the form of a filament, it is referred to as a molten wire deposit.

The composition used according to the present invention advantageously makes it possible to obtain a non-brittle filament with very satisfactory flexibility properties. In particular, said composition has flexural moduli of elasticity (Ef) between 250 and 450 MPa and/or a maximum flexural stress (σfM) between 3 and 5 MPa for a flexural strain (ϵfM) between 2 and 5%, the flexural moduli of elasticity and maximum flexural stress being defined according to ISO 178:2019 test standard.

The filament can thus be advantageously put on a spool, which is the most conventional form for its marketing, it is then said to be easily spooled/coiled up. This means that for bending radii R of more than 100 mm, it is possible to pack the filament on a spool without breaking it.

Another advantage is that the composition used according to the present invention has a good homogeneity as well as a rheology allowing a regular flow during the implementation of the additive manufacturing process.

In particular, said composition exhibits rheofluidizing properties under shear with viscosities(η) between 3000 and 4500 Pa·s for a shear of 20 s-1 reducing to values between 1000 and 1500 Pa·s, for a shear of 100 s-1, the viscosities being measured according to the test standard ISO 11443:2014.

The viscosity of this composition also shows good flow stability with viscosity variations measured over time of the order of 2% to 4% for a given shear. This advantage allows the green part to be printed at a regular rate, leading to articles with very few defects in appearance.

The said composition also makes it possible to obtain a good cohesion between the layers obtained by the successive deposits of composition, this good inter-layer bonding makes it possible to store and transport the green part without altering its structure. The green part can therefore be kept for a few weeks before being transformed into a brown part, without any impact on the final article.

The green parts obtained, after printing, from the composition according to the invention have the mechanical properties described below for a stress perpendicular to the printing laminations: a tensile modulus of elasticity (E) of between 300 and 500 MPa and/or a maximum tensile stress (σtM) of between 1.5 and 3 MPa for a deformation(ϵtM) of between 0.75 and 2%, these mechanical properties are measured according to the test standard ISO 527-1:2019.

The tensile modulus of elasticity (E) is calculated from a tensile test of a specimen between two jaws and a displacement at a controlled speed on a mechanical testing machine. It is determined from the linear elastic deformation curve according to the ISO 527-1:2019 test standard such that:

Modulus of rigidity (MPa)=(σf2−σf1)/(ϵf2−ϵf1) where σf1 is the stress, expressed in MPa, measured at the strain value of ϵf1=0.0005 and σf2 is the stress, expressed in MPa, measured at the strain value of ϵf2=0.0025.

All the rheological and mechanical properties of the composition used according to the invention make it possible to guarantee optimum processing of the filaments on the extrusion-spinning line. The mechanical strength of the composition in the melt and then in the solidification phase allows stable spinning through an extrusion die and then drawing and winding under a tensile stress of between 0.5 and 3 kg, which is the usual range of stress values, depending on the filament diameter and the desired linear winding speed.

Said composition further allows to obtain, by means of a single-screw extrusion line, filaments with a high dimensional stability characterized by a maximum diameter variability of plus (+) or minus (−) 3%.

The said composition makes it possible to obtain printed green parts with optimum dimensional stability, this stability allowing, during the debinding phase, compliance with the final geometries targeted for the brown part.

Furthermore, the composition used allows the production of a brown part with a low and isotropic shrinkage during the sintering stage. The volume shrinkage value is between 35% and 55% by volume measured according to the ISO 21821:2019 test standard. Furthermore, no significant differences were observed between in-plane shrinkage and shrinkage along the removal axis.

The articles obtained by the process according to the invention have a high density, close to the density of the inorganic material used. The residual porosity is between 1.5% and 4% by volume measured according to the ISO 21821:2019 test standard.

The process according to the invention is advantageously used to manufacture articles requiring dimensional stability over a wide range of temperatures, good chemical inertness and increased resistance to abrasion. In particular, these articles can be used in fields such as aeronautics, in particular in the internal part of engines and in the exhaust part of engines; in jewellery; in devices such as filtration devices, reactors, microreactors, catalysts and also for the local reloading of wear parts. The term “local reloading of wear parts” means the local addition of inorganic material to worn parts.

### Compositions

The composition used in the process according to the invention comprises at least one inorganic material in an amount ranging from 75% to 90.75% by weight with respect to the total weight of the composition and from 9.25 to 25 by weight of a polymeric mixture with respect to the total weight of the composition, the polymeric mixture comprising at least one thermoplastic elastomer and at least one low-density polyethylene, the polymeric mixture also comprising the other components, different from the thermoplastic elastomers and low-density polyethylenes, such as for example binders, dispersants, colouring agents, pigments, antioxidants.

The composition used in the process according to the invention therefore consists of an inorganic part and a polymeric part, the inorganic part consisting of one or more inorganic materials and the polymeric part consisting of the thermoplastic elastomer(s) low-density polyethylene(s) and, where appropriate, polyethylene glycol(s) with a molar mass ranging from 5,000 to 20,000 g/mol, polyethylene terephthalate and any other constituents of the composition such as, for example, dispersants, dyes, pigments and antioxidants.

### Inorganic Materials

The composition used in the present invention comprises at least one inorganic material in an amount ranging from 75 to 90.75%, preferably from 82 to 90%, and even more preferably from 83 to 86% by weight based on the total weight of the composition. Typically, said composition comprises at least one inorganic material in an amount of from 50 to 60% by volume based on the total volume of the composition.

All inorganic materials can be used alone or in mixtures.

Generally, inorganic materials are in the form of particles ranging in size from 0.50 to 500 μm.

For the purposes of this text, “particles ranging in size from 0.50 to 500 μm” means particles with a largest dimension size of 0.50 to 500 μm. Typically said inorganic material is in powder form. A powder corresponds to a form factor of 1, the largest dimension being the diameter of the particles forming the powder. Preferably, the diameter of the powders ranges from 0.05 to 100 μm.

In particular, said inorganic material is selected from ceramics, metals, metal alloys.

The term “ceramic” means an article having a vitrified or unvitrified body of crystalline or partially crystalline structure, or of glass, the body of which is formed of essentially inorganic and non-metallic substances, and which is formed by a molten mass which solidifies on cooling, or which is formed and matured, at the same time or subsequently, by the action of heat.

Among the ceramics usable in the present invention, there are -metal oxides, in particular oxides selected from TiO2, MgO, CaO, SiO2, Na2O, Al2O3, ZrO2, Y2O3 and preferably TiO2, ZrO2,
non-oxides, in particular carbides, borides, nitrides, in particular selected from SiC, Si3N4, TiB and AlN.

The metals usable in the present invention are preferably selected from iron, copper, tungsten, titanium, chromium, tin, cobalt, aluminium, molybdenum, tantalum, zirconium, silver, zinc, nickel, carbonyl iron powders and preferably aluminium, titanium, and copper.

In addition, the metals can be pre-treated, in particular by chemical or electrolytic surface treatment, or pre-coated with polymers, oligomers or monomers capable of improving adhesion and the matrix/metal interface, whether covalent or not. The metal treatment may also include complexations by organic molecules causing chelations in order to optimize the matrix/metal interfaces.

Metal alloys for use in the present invention include alloys of a plurality of metals, typically two or three selected from those mentioned above, and alloys of a metal and an element selected from boron, carbon, silicon, phosphorus, sulphur and selenium. In particular, the alloys are chosen from iron alloys such as white cast iron, grey cast iron, steels, tungsten alloys, titanium alloys, copper alloys and aluminium alloys. Preferably, the alloys are chosen from among stainless steels, nickel, chromium and iron alloys, in particular those sold under the Iconel® brand.

According to a preferred embodiment, the inorganic material is in the form of a single or multi modal distribution powder. The particle size distribution may include both sub-micron and micron populations

Preferably, the inorganic material is selected from the group consisting of titanium dioxide (TiO2), zirconium dioxide (ZrO2), aluminium oxide III (Al2O3), silicon carbide (SiC), preferably titanium dioxide. In particular, the inorganic material is multimodal TiO2 marketed under the name TiO2 Kronos® 1000 by the company Kronos Worldwide, Inc.

### Thermoplastic Elastomeric Polymers

The composition used according to the present invention comprises from 9 to 20%, preferably from 9 to 17% and preferably from 9 to 14% by weight of at least one thermoplastic elastomer based on the total weight of the composition.

Thermoplastic elastomers, also called TPEs, are copolymers or blends of polymers that combine the elastic properties of elastomers with thermoplastic properties: they melt and harden, reversibly, under the action of heat. The thermoplastic nature of the material allows it to be used in an extrusion process.

Generally, the TPEs usable in the present invention have a melting point ranging from 100° C. to 300° C., preferably from 150° C. to 250° C. and preferably from 170° C. to 220° C. The methods for determining the melting point of polymers and in particular of TPEs are well known to the skilled person, in particular the melting points of TPEs can be measured by differential scanning calorimetry or DSC for “Differential Scanning calorimetry” in English language according to ISO 11357-1:2016. Indeed, these TPEs must be able to be melted and mixed with the other components to produce homogeneous compositions with the flow properties required for the implementation of an additive manufacturing process by melt deposition.

The TPEs that can be used have a hardness ranging from 20 to 97 Shore A, preferably from 50 to 92 Shore A and most preferably from 60 to 90 Shore A according to ISO 48-4:2018.

Usable TPEs have tensile elongations at break ranging from 100% to 900% preferably from 250% to 800% and most preferably from 300% to 650% according to ISO 37:2017.

Usable TPEs have tensile strengths ranging from 2 MPa to 12 MPa, preferably from 4 MPa to 9 MPa and most preferably from 5 MPa to 8 MPa according to ISO 37:2017.

The TPEs usable according to the present invention are preferably selected from the group consisting of polyurethane TPEs (TPU), styrenic TPEs, copolyester TPEs, copolyamide TPEs (TPA), olefinic TPEs according to the classification derived from the ISO 18064:2014 standard. Preferably they are selected from the group consisting of styrenic TPEs, copolyester TPEs and olefinic TPEs.

Styrenic TPEs, also known as TPE-S or TPS, are block copolymers comprising a rigid segment of the styrene type and a flexible segment selected from the group consisting of polybutadienes, polyisoprene, polyethylene-butene, polyethylene-propylene and polyethylene-ethylene/propylene. Preferably the styrenic TPEs are selected from polystyrene-b-polybutadiene-b-polystyrene called SBS and polystyrene-b-poly(ethylene-butene)-b-polystyrene called SEBS.

TPE copolyesters, also known as TPE-E or TPC, are block copolymers comprising a rigid polyester segment and a flexible polyether segment. They are sometimes called COPE polymers (ether-ester block copolymers).

Olefinic TPEs are blends of thermoplastic polymers and elastomers. They include unvulcanized olefinic TPEs, still called TPE-O or TPO, and vulcanized olefinic TPEs, still called TPE-V or TPV. As TPO, we can mention the unvulcanised PP/EDPM (ethylene-propylene-diene monomer) mixture, as TPV, we can mention the vulcanised PP/EDPM mixture.

Preferably, the TPEs that can be used in the compositions used according to the present invention are TPSs made of SBS-SEBS type copolymers, and more particularly from the Thermolast® K range marketed by the company Kraiburg TPE under references TF4-CGT, TF5-CGT, TF6-CGT, TF7-CGT, TF8-CGT or TF9-CGT or from the Dynaflex® range marketed by the company Polyone under reference G7640-1, G2701-1000-01, G3204-1000-03 or G7690-1.

### Low Density Polyethylene

The composition used according to the present invention comprises from 0.25 to 5%, preferably from 1 to 4.7% and preferably from 2 to 4.5% by weight of at least one low density polyethylene based on the total weight of the composition.

The polyethylenes that can be used are the low density polyethylenes generally called LDPE or “low density polyethylene” and the linear low density polyethylenes LLDPE. Their density generally ranges from 0.91 to 0.94 g/cm3 according to the ISO 1183-2:2019 test standard.

### Polyethylene Glycol

Advantageously, the composition used according to the present invention comprises polyethylene glycol (PEG) with a molar mass ranging from 5000 to 20000 g/mol.

More particularly, the composition used according to the present invention comprises from 0 to 5%, preferably from 0.5 to 4% and preferably from 1 to 3% by weight of polyethylene glycol with a molar mass ranging from 5000 to 20000 g/mol, preferably 6000 to 20000 g/mol based on the total weight of the composition. Preferably, the polyethylene glycol is selected from polyethylene glycol with a molar mass equal to 8000 g/mol (PEG 8000) and polyethylene glycol with a molar mass equal to 20000 g/mol (PEG 20000).

### Poly(Ethylene Terephthalate) or PET

The composition used according to the present invention comprises from 0 to 3%, preferably from 0.5 to 2.5% and preferably from 1 to 2.2% by weight of polyethylene terephthalate, preferably glycol polyethylene terephthalate, based on the total weight of the composition.

### Additives

As additives which can be used in the compositions used according to the invention, mention may be made of dispersants, dyes, pigments and antioxidants.

### Process for the Preparation of the Composition

The composition used according to the present invention is prepared by mixing the components of the composition namely inorganic material(s), thermoplastic elastomer(s), low density polyethylene(s), preferably by means of a co-rotating twin screw extruder.

Generally, the components are dosed separately using gravimetric dosing devices and then introduced through a hopper located at the inlet of the twin-screw extruder at the level of the material feed head. The screw/drum assembly making up the co-rotating twin-screw extruder is advantageously heated to a “process temperature” Tp higher than the melting temperature of the polymer of the composition having the highest melting point Tmax. Said process temperature Tp is preferably chosen between Tmax and Tmax+20° C. Typically Tp ranges from 170 to 240° C.

Preferably, the composition used according to the present invention is prepared according to a process comprising the following steps, in this order: i) separate metering of the components by means of gravimetric dosing devices and introduction, into the hopper of a co-rotating twin-screw extruder, of the inorganic part and the polymeric part comprising the thermoplastic elastomer(s), the low-density polyethylene(s), if appropriate the polyethylene glycol(s) with a molar mass ranging from 5000 to 20000 g/mol, and, if appropriate, the polyethylene terephthalate then heating to a temperature Tp of between the melting temperature of the polymer with the highest melting point Tmax of the composition and the said temperature Tmax+20° C., the rotational speed of the screws of the co-rotating twin-screw extruder is set at between 100 and 800 RPM, that is to say revolutions per minute, preferably between 200 and 600 RPM and more preferably between 250 and 450 RPM;
ii) mixing by passing through the co-rotating twin-screw extruder and recovering the mixture obtained in the form of rods with a diameter of between 2 and 4 mm, cooled in air, and transformed into cylindrical pellets with a diameter of between 2 and 4 mm and a length of between 1.5 and 5 mm with the aid of a granulator with rotating knives, or cutting under water at the head of the die in order to obtain spherical pellets with a diameter of between 0.5 and 3 mm.

According to a first embodiment, the pellets obtained are transformed into calibrated filaments and packaged in the form of bobbins with the aid of an extrusion-spinning line consisting of a single-screw extruder, a tank for cooling the filaments under water, a rotary drawer, an optical bidirectional dimensional control device and a winding/transfer device. The conformation and calibration of the filament is done according to the dimensional standards for 3D printing by molten wire deposition, i.e., according to a filament diameter of 1.75 mm or 2.85 mm.

According to a second embodiment, the pellets obtained are transformed into calibrated filaments with the help of an extrusion-spinning line composed of a single-screw extruder, a tank for cooling the filaments under water, a rotary drawer and an optical bidirectional dimensional control device. The conformation and calibration of the filament are carried out in order to obtain a filament with a diameter of between 0.5 and 1.5 mm intended to be granulated by a rotary knife granulator allowing the obtaining of cylindrical micro-pellets with diameters of between 0.5 and 1.5 mm and lengths of between 0.5 and 1.5 mm intended for 3D printing with the aid of a micro-pellet extruder.

### Method of Preparation of the Article

The present invention is further directed to a method of preparation of an article according to the present invention from a composition used according to the present invention comprising the following steps, in this order:
i) place a composition used according to the present invention in the feed zone of a printer for additive manufacturing by melt deposition,
ii) drive said composition towards the print head of the printer composed of a heating body and a printing nozzle, preferably of cylindrical section, where said composition is brought to a temperature Tc comprised between the melting temperature of the composition and said melting temperature of the composition+20° C.,
iii) extrude the molten composition through the nozzle of the printing head to form a three-dimensional green part by deposition of successive layers,
iv) remove at least part of the polymeric part of the green part by heating to form a brown part,
v) sinter the brown part to form an article comprising at least 99% by weight of inorganic material(s) relative to the total weight of the article.

Step i)

The composition introduced into the feed zone can be in the form of pellets, in which case the printer used is equipped with a pellet extruder.

Preferably, the composition introduced into the feed zone is in the form of a filament, the printer used being a 3D printer using molten wire deposition.

Step ii)

Generally, the temperature Tc defined in step ii) ranges from 170 to 240° C.

Step iv)

This step corresponds to a debinding intended to remove, at least in part, the polymeric part of the green part while preserving the shape of the part, the part obtained is the brown part.

This step is generally carried out by thermal means preceded by chemical debinding, using a solvent.

The composition used according to the present invention advantageously makes it possible to dispense with the chemical debinding step. Debinding can only be carried out thermally.

The thermal debinding step is performed in an oven under inert gas, such as nitrogen or argon. The green part is thus subjected to a thermal cycle made up of different temperature stages generally corresponding to the thermal debinding of each component/polymer. These stages are generally two to four in number and their temperatures are between 80° C. and 600° C. for respective durations of between 1 H and 8 H.

After this thermal debinding, the polymeric phase content by weight of the part, called brown part, ranges from 1 to 3% by weight of polymer(s) with respect to the total weight of the part.

According to a particular mode of the invention, in step iv) the heating is preceded by a step of immersing the green part in an aqueous or hydroalcoholic solution, possibly in the presence of ultrasound.

When an immersion step, i.e. chemical debinding, is carried out, it usually lasts from 30 minutes to 12 hours. Preferably, after this treatment, the mass content of the polymeric phase in the part ranges from 3 to 18% by weight with respect to the total weight of the part.

The solution used for chemical debinding is an aqueous or hydroalcoholic solution consisting of water and at least one C1-C5alcohol. Preferably the said C1-C5 alcohol is chosen from methanol, ethanol, propanols, in particular isopropanol, butanols, pentanols and mixtures thereof in any proportions, preferably the alcohol used is isopropanol.

Preferably the aqueous or hydroalcoholic solution consists of water and from 0 to 80% by weight of a C1-C5 alcohol, based on the total weight of the solution.

This step can also be carried out in the presence of ultrasound, the ultrasound treatment is carried out using a 40 kHz ultrasound probe with a total power of 200 to 800 watts.

The chemical debinding may also include an acid treatment, in particular by means of a gas.

Step v)

Step v) is a sintering step. The implementation of this step is within the competence of the skilled person.

Generally, when the inorganic material is a ceramic, the sintering step is carried out at a temperature of from 1000 to 2000° C. Generally, when the inorganic material is a metal, the sintering step is performed at a temperature of 800 to 1000° C.

The sintered parts have an isotropic dimensional shrinkage of between 35 and 55% by volume compared to the green part. The porosity of this sintered part is between 2 and 10% by volume according to the ISO 18754:2013 test standard.

The following examples are intended to illustrate the invention without limiting its scope.

### EXAMPLES

Examples 1 to 5 correspond to compositions in accordance with the invention, while Examples C6 to C10 are comparative examples.

The quantities by weight of the compositions are given in grams.

The following components are used to prepare the compositions:

^{(a)}TiO2 with a particle size distribution of d10=90 nm, d50=145 nm and d90=200 nm marketed under the name TiO22 Kronos® 1000 by the company Kronos Worldwide, Inc.
^{(b1)}TPE:Thermolast® K TF9CGT marketed by the company Kraiburg.
^{(b2)}TPE:Thermolast® K TF7CGT marketed by Kraiburg;
^{(d1)}PEG 8000 marketed by Sigma-Aldrich;
^{(d2)}PEG 20000 marketed by Sigma-Aldrich;
^{(c)}Low density polyethylene: Escorene LLN1001XV marketed by Exxonmobil Chemical with a density of 0.918 g/cm3 according to the ISO 1183-2:2019 test standard.

The compositions are prepared by dosing the components at the inlet of the co-rotating twin-screw extruder using two Brabender Technologie gravimetric dosing units, respectively referenced DSR28 and DDSR 20. The first dosing unit is dedicated to the dosing of the polymeric part of the pre-mixed composition in the form of a dry blend. The second dispenser is dedicated to the inorganic part of the composition. The cumulative flow rate of these two dosing units is set at 4 kg/H. The co-rotating twin-screw extruder used is a model FSCM 21 (Screw diameter=21 mm L/D=40) from the manufacturer TSA Industriale equipped with a 3 rod die of 3 mm diameter. The process temperature (Tp) is set at 190° C. and the rotation speed is set at 400 RPM for all compositions. The rushes are cooled at the die exit with ambient air on a conveyor belt and then pelletized with a rotary cutter pelletizer.

### Example 1

Example 1 is carried out with a single type of TPE, Thermolast® K TF9CGT.

TABLE 1

| | | Quantity | Quantity |
|---|---|---|---|
| Component | density | by weight | by volume |
| TiO₂^{(a)} | 4 | 85.06 | 56.66 |
| TPE^{(b1)} | 0.89 | 9.45 | 28.30 |
| PEG 8000^{(d1)} | 0.89 | 2.74 | 8.21 |
| Low density polyethylene ^{(c)} | 1.07 | 2.75 | 6.83 |

Examples 2 to 5 are made with two types of TPE: Thermolast® K TF9CGT and Thermolast® K TF7CGT.

### Example 2

TABLE 2

| | | Quantity | Quantity |
|---|---|---|---|
| | | by weight | by volume |
| Component | density | Quantity | Quantity |
| Component | density | by weight | by volume |
| TiO₂^{(a)} | 4 | 84.73 | 55.97 |
| TPE^{(b1)} | 0.89 | 8.98 | 26.63 |
| TPE^{(b2)} | 0.89 | 1.99 | 5.91 |
| PEG 8000^{(d1)} | 1.07 | 2.15 | 5.31 |
| Low density polyethylene ^{(c)} | 0.918 | 2.15 | 6.19 |

### Example 3

TABLE 3

| | | Quantity | Quantity |
|---|---|---|---|
| Component | density | by weight | by volume |
| TiO₂^{(a)} | 4 | 83.17 | 52.85 |
| TPE^{(b1)} | 0.89 | 10.99 | 31.39 |
| TPE^{(b2)} | 0.89 | 2.19 | 6.24 |
| PEG 8000^{(d1)} | 1.07 | 1.46 | 3.47 |
| Low density polyethylene ^{(c)} | 0.918 | 2.19 | 6.05 |

### Example 4

TABLE 4

| | | Quantity | Quantity |
|---|---|---|---|
| Component | density | by weight | by volume |
| TiO₂^{(a)} | 4 | 83.17 | 52.91 |
| TPE^{(b1)} | 0.89 | 9.00 | 25.73 |
| TPE^{(b2)} | 0.89 | 2.18 | 6.25 |
| PEG 20000^{(d2)} | 1.07 | 1.45 | 3.48 |
| Low density polyethylene ^{(c)} | 0.918 | 4.20 | 11.64 |

### Example 5

TABLE 5

| | | Quantity | Quantity |
|---|---|---|---|
| Component | density | by weight | by volume |
| TiO₂^{(a)} | 4 | 83.17 | 52.85 |
| TPE^{(b1)} | 0.89 | 10.99 | 31.39 |
| TPE^{(b2)} | 0.89 | 2.19 | 6.24 |
| PEG 20000^{(d2)} | 1.07 | 1.46 | 3.47 |
| Low density polyethylene ^{(c)} | 0.918 | 2.19 | 6.05 |

Comparative examples C6 and C7 do not include low density polyethylene.

### Example C6

TABLE 6

| | | Quantity | Quantity |
|---|---|---|---|
| Component | density | by weight | by volume |
| TiO₂^{(a)} | 4 | 90 | 66.69 |
| TPE^{(b2)} | 0.89 | 10 | 33.31 |

### Example C6

TABLE 7

| | | Quantity | Quantity |
|---|---|---|---|
| Component | density | by weight | by volume |
| TiO₂^{(a)} | 4 | 87 | 60.14 |
| TPE^{(b2)} | 0.89 | 12 | 37.28 |
| PEG 8000^{(d1)} | 1.07 | 1 | 2.58 |

### Mechanical Properties in Bending

The flexural moduli, flexural strain and maximum flexural stress of the conforming compositions of Examples 2 to 5 are determined according to the ISO 178:2019 test standard for 3-point bending tests at room temperature of 23° C. and RH=50%. The tests are carried out using test specimens obtained by thermocompression of plates at a Tp temperature of 180-190° C. and a pressure of 10 bar. This standardized implementation makes it possible to determine only the differences in intrinsic properties related to the formulation, without the bias generated by the inter-compositional mechanical properties related to the 3D printing process.

The values obtained are presented in Table 8.

TABLE 8

| | Modulus of | | |
|---|---|---|---|
| | elasticity in | Bending | Maximum |
| | bending Ef | strains εfM | bending stress |
| Formulation | (Mpa) | (%) | σfM (Mpa) |
| Example 2 | 407 | 2.31 | 3.90 |
| Example 3 | 306 | 2.10 | 3.20 |
| Example 4 | 411 | 2.66 | 4.13 |
| Example 5 | 352 | 1.90 | 3.75 |

The compositions of examples 2 to 5 exhibit homogeneous properties characterised by ductile behaviour with a low modulus of elasticity below the 700 MPa limit representing the lower limit of stiffness of a plastic as described in ISO 178:2019-3.13. These compositions therefore have good flexibility, allowing them to be wound in the form of filaments.

### Rheological Properties

The viscosity of the compositions of examples 2 to 5, according to the invention, and of the comparative compositions C6 and C7 were obtained by capillary rheology at different shear rates, these viscosities are determined according to the ISO 11443 test standard: 2014 with a test temperature of 180° C. and a 1mm diameter die with L/D=10 ratio.

The values obtained are presented in table 9.

TABLE 9

| | Apparent | Apparent | Apparent |
|---|---|---|---|
| | viscosity | viscosity | viscosity |
| | at 20 s−1 | at 50 s−1 | at 100 s−1 |
| Formulation | (Pa · s) | (Pa · s) | (Pa · s) |
| Example 2 | 3396.7 | 1787,3 | 1083.2 |
| Example 3 | 3205.4 | 1703.4 | 1010.4 |
| Example 4 | 4037.5 | 2228.9 | 1342.1 |
| Example 5 | 4024.4 | 2078.4 | 1196.4 |
| Example C6 | 8280.3 | 3406.4 | 1815.0 |
| Example C6 | 8959.4 | 3848.4 | 2078.7 |

The compliant compositions of examples 2 to 5 have homogeneous and sufficiently moderate viscosities, at shear rates of the order of those used in filament-type or micro-extruder-type 3D printing heads fitted to conventional additive manufacturing devices. These compositions can therefore be used in additive manufacturing processes by deposition of molten material.

The comparative compositions of examples C6 and C7, have higher viscosities making their use in the low shear conditions of additive manufacturing processes impossible or inconsistent.

### Preparing Articles

Articles were prepared from the conforming compositions of examples 3 and 5. Thus, one article was produced from a filament (diameter 2.85mm) of the composition of Example 3 and another was produced from micro-pellets (diameter 1.5mm and length 2mm) from the composition of example 5.

15 m of filament of the composition of example 3 was fed into the head of the feed zone of a Prusa 13 Reworks printer from the manufacturer eMotionTech. The filament is driven by a Bondtech direct drive extruder, then the composition is driven to the print head of the printer where it is heated to a temperature Tc of 210° C. The molten composition is extruded through the nozzle of the print head with a diameter of 0.8 mm at a displacement speed of 10 mm/s so as to form a three-dimensional green part with a cubic shape of 15 mm on each side by depositing successive layers. The material deposit plate is heated to a temperature of 70° C. during the printing process.

40 g of micropellets of the composition of Example 5 are introduced into the feed area of a Prusa 13 Reworks printer from the manufacturer eMotionTech. The micro pellets are driven by a Mahor XYZ pellet extruder, then the composition is driven to the print head of the printer where it is heated to a temperature Tc of 210° C. The molten composition is extruded through the nozzle of the print head with a diameter of 0.8 mm at a speed of 10 mm/s so as to form a three-dimensional green part with a cubic shape of 15 mm on each side by depositing successive layers. The material deposit plate is heated to a temperature of 70° C. during the printing process.

The green parts are then debonded by heating in a first stage of 1 H at 250° C. followed by a second stage of 1 H at 500° C. to obtain three-dimensional brown parts with a polymeric phase content by weight of 3% relative to the total weight of the brown parts.

Finally, the brown parts are sintered by heating at 1500° C. for 2 hours. The resulting articles comprise 99% by weight of inorganic material(s), the articles have isotropic shrinkage of the order of 47% by volume.

### Additional Comparative Examples

### Example C6

TABLE 10

| | | Quantity | Quantity |
|---|---|---|---|
| Component | density | by weight | by volume |
| TiO₂^{(a)} | 4 | 92 | 71.90 |
| TPE^{(b1)} | 0.89 | 8 | 28.10 |

The composition of Comparative Example C8 comprises a TPE in a lower amount than the compositions according to the invention.

The C8 composition cannot be suitably shaped. When it is formulated in pellets, they are crumbly and their distribution is not homogeneous. As a result, these pellets cannot be used in an additive manufacturing process because they do not provide a consistent flow rate. When formulated as a filament, the filament is too stiff to be windable. Composition C8 cannot be used in a 3D printing process by melt deposition.

Example C9

TABLE 11

| | | Quantity | Quantity |
|---|---|---|---|
| Component | density | by weight | by volume |
| TiO₂^{(a)} | 4 | 78 | 44.10 |
| TPE^{(b2)} | 0.89 | 22 | 55.90 |

The composition of comparative example C9 comprises TPEs, in an amount greater than that of the compositions according to the invention.

Composition C9 is too soft to be used in a 3D printing process by melt deposition.

Example C10

TABLE 12

| | | Quantity | Quantity |
|---|---|---|---|
| Component | density | by weight | by volume |
| TiO₂^{(a)} | 4 | 81.2 | 49.46 |
| TPE^{(b1)} | 0.89 | 9.0 | 24.64 |
| TPE^{(b2)} | 0.89 | 2.2 | 6.02 |
| PEG 8000^{(d1)} | 1.07 | 1.5 | 3.42 |
| Low density polyethylene ^{(c)} | 0.918 | 6.1 | 16.46 |

The composition of comparative example C10 comprises low density polyethylene in an amount greater than that of the compositions according to the invention.

The C10 composition tends to crystallize during the additive manufacturing process. The green part obtained has a poor inter-layer cohesion leading to delamination of the article.

1. A melt-deposition additive composition comprising:
a) from 75 to 90.75% by weight of at least one inorganic material relative to the total weight of the composition; and
b) a polymer phase comprising:
from 9 to 20% by weight of at least one thermoplastic elastomer, based on the total weight of the composition,
from 0.25 to 5% by weight of at least one low density polyethylene, based on the total weight of the composition,
from 0 to 5% by weight of at least one polyethylene glycol having a molar mass of from 5,000 to 20,000 g/mol, based on the total weight of the composition,
from 0 to 3% by weight of polyethylene terephthalate based on the total weight of the composition.

2. The melt-deposition additive composition according to claim 1, wherein the inorganic material is in the form of particles having a largest dimension size of from 0.50 to 500 μm.

3. The melt-deposition additive composition according to claim 1, wherein the at least one inorganic material is in the form of a powder.

4. The melt-deposition additive composition according to claim 1, wherein the at least one inorganic material is selected from the group consisting of titanium dioxide, zirconium dioxide, aluminium oxide III and silicon carbide.

5. The melt-deposition additive composition according to claim 1, wherein the thermoplastic elastomer is selected from the group consisting of polyurethane TPEs, styrenic TPEs, copolyester TPEs copolyamide TPEs and olefinic TPEs.

6. The melt-deposition additive composition according to claim 5, wherein the thermoplastic elastomer is a styrenic TPE selected from polystyrene-b-polybutadiene-b-polystyrene and polystyrene-b-poly(ethylene-butene)-b-polystyrene.

7. The melt-deposition additive composition according to claim 1, wherein the composition is in a form selected from the group consisting of pellets and filaments.

8. The melt-deposition additive composition according to claim 1, wherein the composition comprises from 9 to 14% by weight of at least one thermoplastic elastomer, based on the total weight of the composition.

9. The melt-deposition additive composition according to claim 1, wherein the composition comprises from 2 to 4.5% by weight of at least one low density polyethylene, based on the total weight of the composition.

10. The melt-deposition additive composition according to claim 1, wherein the composition comprises from 1 to 3% by weight of at least one polyethylene glycol having a molar mass of from 5,000 to 20,000 g/mol, based on the total weight of the composition.

11. The melt-deposition additive composition according to claim 1, wherein the composition comprises from 83 to 86% by weight of at least one inorganic material relative to the total weight of the composition.

12. A method of manufacturing an article by 3D printing comprising the following steps, in this order:
i) placing the melt-deposition additive composition according to claim 1 in a feed area of a printer for additive melt deposition manufacturing,
ii) driving said composition to the print head of the printer consisting of a heating body and a print nozzle where said composition is brought to a temperature Tc between the melting temperature of the composition and said melting temperature of the composition +20° C. to form a molten composition,
iii) extruding the molten composition through the nozzle of the printing head to form a three-dimensional green part by deposition of successive layers,
iv) removing at least part of a polymeric part of the green part by heating to form a three-dimensional brown part,
v) sintering the brown part to form an article comprising at least 99% by weight of inorganic material(s) with respect to the total weight of the article.

13. The method according to claim 12, wherein the temperature Tc defined in step ii) ranges from 170 to 240° C.

14. The method according to claim 12, wherein, in step iv, the heating is preceded by a step of immersing the green part in an aqueous or hydroalcoholic solution optionally in the presence of ultrasound.

15. An article obtained from the melt-deposition additive composition according to claim 1, comprising at least 99% by weight of inorganic material(s) based on the total weight of the article.

16. An aeronautic engine, comprising the article according to claim 15 in an internal part of the engine or in an exhaust part of the engine.

17. Jewellery comprising the article according to claim 15.

18. A device comprising the article according to claim 15, wherein the device is a filtering device, reactor, microreactor or catalyst.

19. A device comprising the article according to claim 15, wherein article is added to worn parts.

20. An article obtained according to the process according to claim 12, comprising at least 99% by weight of inorganic material(s) based on the total weight of the article.
